(19) United States
(12) Patent Application Publication
(10) Pub. No.: US 2010/0024608 A1
(43) Pub. Date: Feb. 4, 2010

(54) TOOL CONNECTING ROD WITH CONVERTIBLE CONNECTORS

(76) Inventor: Ho-Yi CHEN, Wuci Township (TW)

Correspondence Address: EGBERT LAW OFFICES, 412 MAIN STREET, 7TH FLOOR, HOUSTON, TX, 77002, US

(21) Appl. No.: 12/471,432

(22) Filed: May 25, 2009

(30) Foreign Application Priority Data
Aug. 3, 2008 (TW) 097215839

(51) Int. Cl. B25B 23/16; B25G 1/04

(52) U.S. Cl. 81/177.2; 81/177.85

(57) ABSTRACT

The present invention provides a tool connecting rod with convertible connectors. The invention includes an outer cylinder, an inner slide, a drive rod, an angular inner rod, an elastic supporting member and first and second locating members. If the drive rod is individually fixed, the tool connecting rod enables its working end to be inserted by the screwdrivers or bolts, or be sleeved optionally for time-saving, ease-of-use and higher flexibility.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a tool connecting rod, and more particularly to an innovative tool connecting rod with convertible connectors.

2. Description of Related Art Including Information Disclosed Under 37 CFR 1.97 and 37 CFR 1.98

The adjustable connectors for electrical hoists can be generally used for assembly and replacement of different screwdrivers or drills. However, given the bigger external diameter of the connectors for electrical hoists, the connectors cannot be extended into the narrow and deep gap wherein the screws to be loosened are stuck; hence, a screwdriver connecting rod has been developed accordingly. One end of the screwdriver connecting rod is generally provided with a mating portion for assembly onto the connector of electrical hoist, and the other end is extended to a set length is provided with a screwdriver slot for insertion of the screwdriver. Such a screwdriver connecting rod can be extended functionally, but it is observed from actual experience that the screwdriver slot can only used for insertion of the screwdriver, other than the sleeve. In such a case, when the users are intended for screwing or loosening the hex bolts or nuts, the screwdriver connecting rod cannot function well.

As disclosed technically by Taiwan Patent No. M315142, entitled “Dual-Purpose Connecting Rod”, a guide rod that can slide flexibly in a guide sleeve is used to convert the connecting rods for screwdriver or sleeve into two different drive modes. Yet, it is observed that the working mode will change in tune with conversion of the connecting rods for screwdriver or sleeve; namely, the working end is changed into the second polygonal slot when then screwdriver connecting rod is used for the drive mode, or changed into a lug (for assembly of sleeve) when the sleeve connecting rod is used for the drive mode. As the drive end and working end are fixed structurally, the driving unit must be changed from an electrical handle (or pneumatic handle) into a quadrangular spanner if the intended object of the user is converted from a cross or straight screw into a hexagonal bolt or nut, leading to inconvenient operation. Moreover, if the quadrangular spanner is currently unavailable, the screwing or loosening of hex bolts and nuts is made impossible. It is thus learnt that there is still room for improvement of the structure of the typical connecting rod. Alternatively, as disclosed in U.S. Pat. No. 7,278,342, a connecting rod already extended can swing universally for an inward locking state, but this connecting rod can only be used for assembly of a single tool, rather than for multiple tools, making it necessary for further improvement.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

Based on the present invention, a tool connecting rod with convertible connectors mainly comprises an outer cylinder, an inner slide, a drive rod, an angular inner rod, an elastic supporting member, and first and second locating members. If the drive rod is individually fixed, the tool connecting rod enables its working end to be inserted by the screwdrivers or bolts, or be sleeved optionally for time-saving, ease-of-use and higher flexibility.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an assembled perspective view of the preferred embodiment of the present invention.

FIG. 2 shows an exploded perspective view of the preferred embodiment of the present invention.

FIG. 3 shows an assembled sectional view of the preferred embodiment of the present invention.

FIG. 4 shows an assembled sectional view of operating mode 1 of the present invention.

FIG. 5 shows an assembled sectional view of operating mode 2 of the present invention.

FIG. 6 shows an assembled sectional view of operating mode 3 of the present invention.

### DETAILED DESCRIPTION OF THE INVENTION

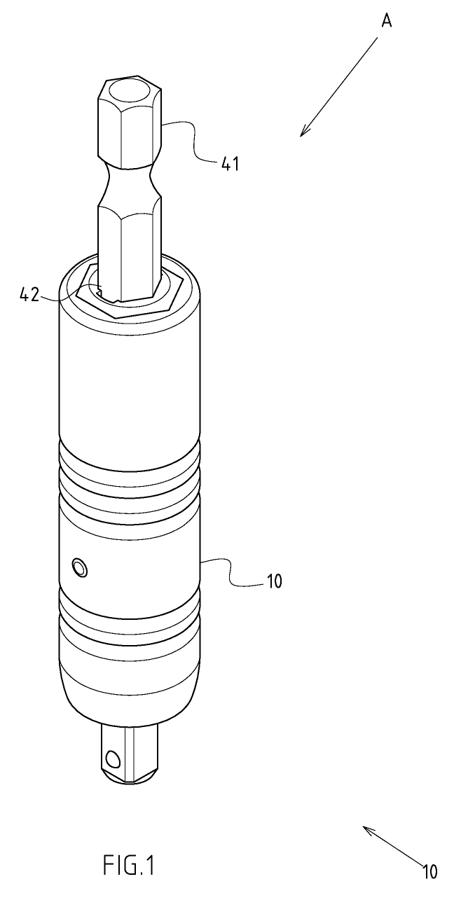

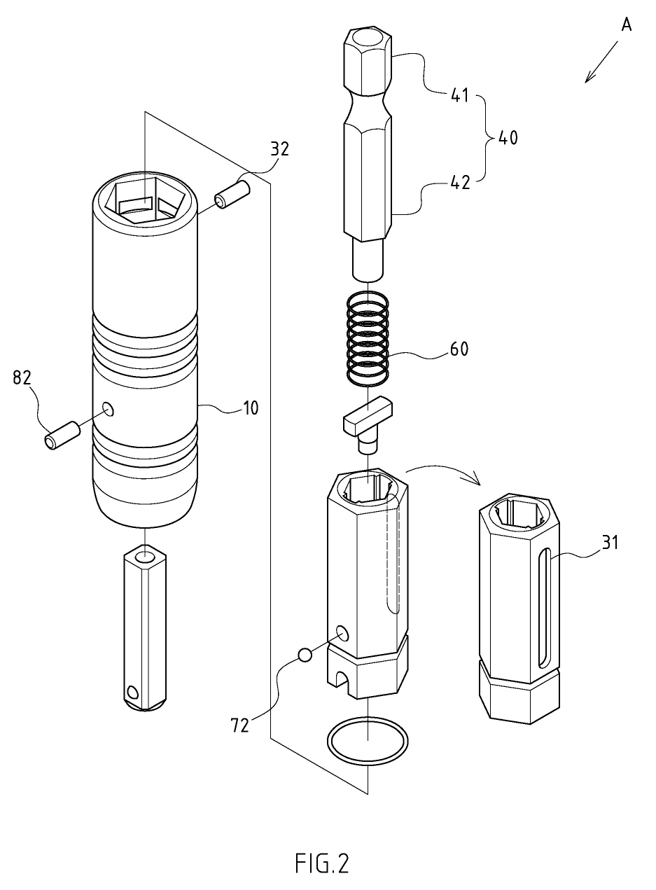

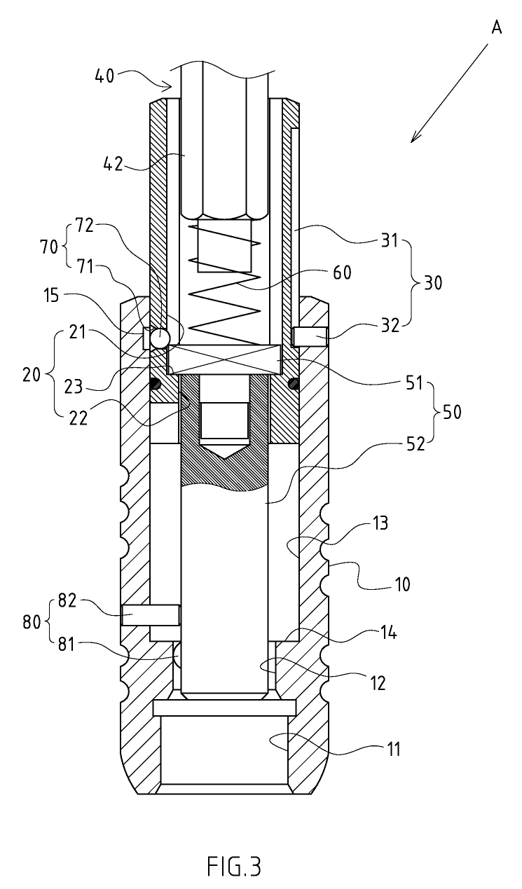

FIGS. 1-3 depict preferred embodiments of a tool connecting rod of the present invention with convertible connectors. The embodiments are provided for only explanatory objectives with respect to the patent claims.

The tool connecting rod A comprises an outer cylinder 10, in the first end of which a first polygonal slot 11 and a second polygonal slot 12 of aperture difference are formed, and in the second end of which a guide slot 13 is formed. The interior of the guide slot 13 is connected with the second polygonal slot 12, while a first limit flange 14 is defined between the interior of the guide slot 13 and the second polygonal slot 12. The cross sections of the first polygonal slot 11 and second polygonal slot 12 of the present invention are designed into a hexagonal pattern. An inner slide 20 can slide directionally and also be assembled into the guide slot 13 of the outer cylinder 10. Moreover, a retainer 30 is used to confine the maximum extension range of inner slide 20. At the center of the inner slide 20, a stepped hollow space is used to form a chamber 21, a reducing port 22 and a second limit flange 23 arranged between the chamber 21 and reducing port 22. The cross sections of the inner slide 20 and guide slot 13 of the outer cylinder 10 can be designed into a polygonal pattern (e.g. hexagon), such that the inner slide 20 can slide directionally. The retainer 30 is composed of a long groove 31 at one side of the inner slide 20, and a flanged pin 32 correspondingly to the guide slot 13 of the outer cylinder 10.

There is a drive rod 40, containing a driving end 41 and a mating end 42. The mating end 42 is fixed on one end of the inner slide 20 with a chamber 21. The driving end 41 is protruded to a length. In the preferred embodiment, the mating end 42 is tightly inserted into the chamber 21 of the inner slide 20 for secure positioning.

An angular inner rod 50 contains a limiting seat 51 and a protruding end 52. The limiting seat 51 slides in the chamber 21 of the inner slide 20, whilst the protruding end 52 protrudes towards the guide slot 13 of the outer cylinder 10 after passing through the reducing port 22 of the inner slide 20. The protruding end 52 under a preset maximum protruding state is protruded out of the first polygonal slot 11 of the outer cylinder 10. Moreover, the protruding end 52 under a preset maximum retraction state is retracted into the guide slot 13 of the outer cylinder 10.

A elastic supporting member 60 is made of a helical spring and assembled into the chamber 21 of the inner slide 20 to support flexibly the angular inner rod 50 towards the guide slot 13 of the outer cylinder 10.

A first locating member 70 is formed onto the preset location of the chamber 21 of the inner slide 20 and used to position the protruding end 52 of the angular inner rod 50 under preset maximum protruding state. In the preferred embodiment, the first locating member 70 is composed of a through-hole 71 arranged on the side wall of the chamber 21 of the inner slide 20 and a bead 72 in the through-hole 71. When the protruding end 52 of the angular inner rod 50 is under a preset maximum protruding state, and when the inner slide 20 is retracted into the guide slot 13 of the outer cylinder 10, the interior of the bead 72 is solidly protruded from the chamber 21 of the inner slide 20 and abutted onto the limiting seat 51 of the angular inner rod 50. A tank 15 is laterally set on the guide slot 13 of the outer cylinder 10. When the inner slide 20 is pulled externally, the bead 72 aligning with the tank 15 can be retracted for a release state, such that the angular inner rod 50 can slide inwards.

A second locating member 80 is arranged between the guide slot 13 of the outer cylinder 10 and the angular inner rod 50, enabling the preset maximum retraction state of the angular inner rod 50 to be locked securely. The second locating member 80 of the preferred embodiment contains an elastic bead 81 protruded laterally on the angular inner rod 50, and a bumping post 82 arranged correspondingly to the guide slot 13 of the outer cylinder 10. When the angular inner rod 50 is under a preset maximum retraction state, the elastic bead 81 is used for abutting securely onto the bumping post 82.

Based upon above-specified structures, the present invention is operated as follows.

The tool connecting rod A is operated in such a manner that the driving end 41 of the drive rod 40 is assembled on the driving end of existing electrical handle (or pneumatic handle). The first end (working end) of the outer cylinder 10 is available with three operating modes for optional conversion as illustrated below:

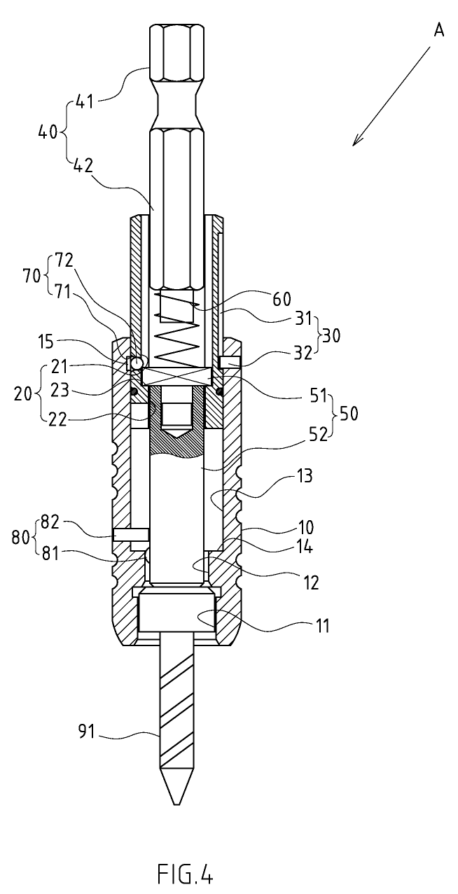

Referring to FIG. 4, when the inner slide 20 is pulled to maximum length, the angular inner rod 50 is flexibly braced by the elastic supporting member 60, so that the protruding end 52 is protruded into the second polygonal slot 12 of the outer cylinder 10. In such a case, the first polygonal slot 11 of the outer cylinder 10 allows for insertion of the head of bolt 91, thereby driving the rotation of the bolt 91.

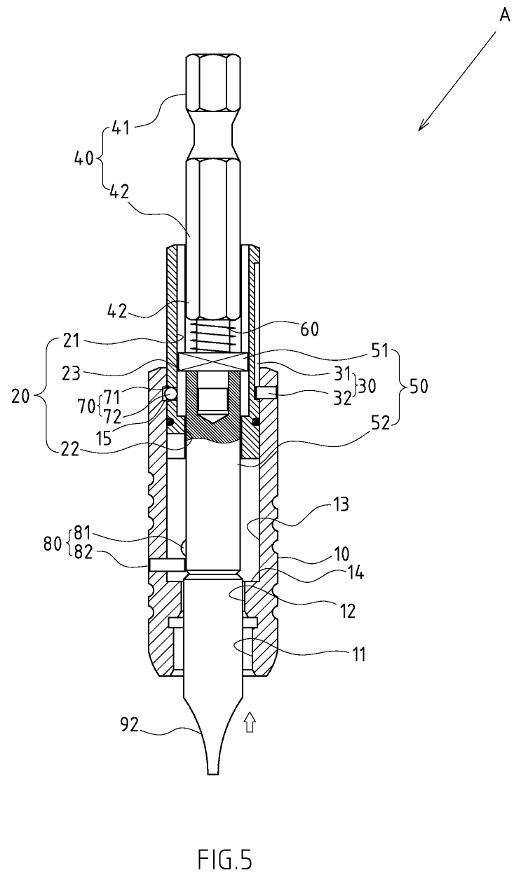

Referring also to FIG. 5, the screwdriver 92 can also be inserted into the first polygonal slot 11 and then into the second polygonal slot 12. During this process, the screwdriver 92 will press the angular inner rod 50 inwards until the limiting seat 51 of the angular inner rod 50 reaches the mating end 42 of the drive rod 40. In such a case, the elastic supporting member 60 will be squeezed to accumulate elastic restoring force, and the retraction state of the angular inner rod 50 will be locked securely by the second locating member 80, thereby driving the rotation of the screwdriver 92. Under this operating mode, when the outer cylinder 10 is pulled towards the drive rod 40 to make the bumping post 82 of the second locating member 80 span across the elastic bead 81, the angular inner rod 50 will be immediately turned into a release state, and then yield an impact towards the second polygonal slot 12 to push out the screwdriver 92 under the elastic release of the elastic supporting member 60.

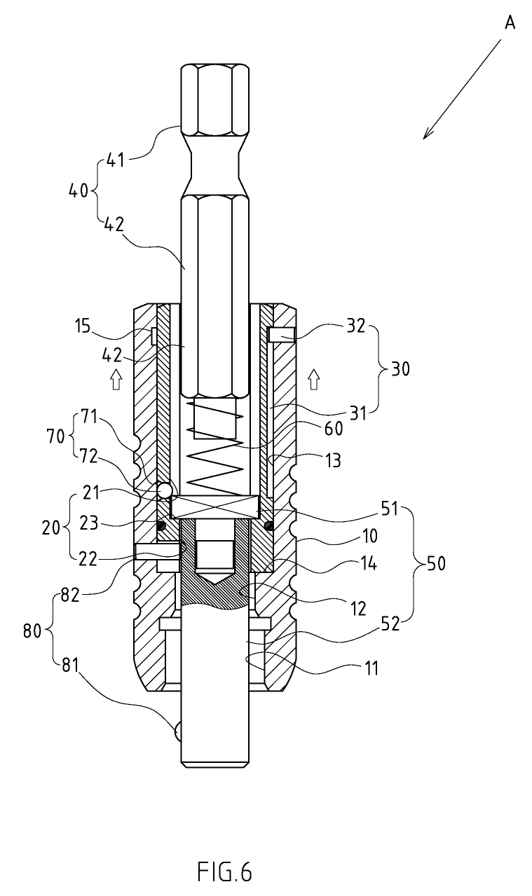

Referring to FIG. 6, when the inner slide 20 is pushed inwards and fully embedded into the guide slot 13 of the outer cylinder 10, the protruding end 52 of the angular inner rod 50 will protrude out of the first polygonal slot 11 of the outer cylinder 10 in a preset maximum protruding state. Moreover, the angular inner rod 50 can be positioned securely if the interior of the bead 72 of the first locating member 70 is solidly abutted onto the limiting seat 51. In such a case, the protruding portion of the protruding end 52 of the angular inner rod 50 could be used for sleeving purpose, thereby driving the rotation of the sleeve.

1. A tool connecting rod with convertible connectors, the connecting rod comprising:
an outer cylinder, in the first end of which a first polygonal slot and a second polygonal slot of aperture difference are formed; in the second end of which a guide slot is formed; the interior of the guide slot is connected with the second polygonal slot, while a first limit flange is defined between the interior of the guide slot and the second polygonal slot;
an inner slide, which can slide directionally and also be assembled into the guide slot of the outer cylinder, wherein a retainer is used to confine the maximum extension range of inner slide, wherein, at the center of the inner slide, a stepped hollow space is used to form a chamber, a reducing port and a second limit flange arranged between the chamber and reducing port;
a drive rod, containing a driving end and a mating end said mating end being fixed on one end of the inner slide with a chamber and having a driving end protruded to a set length;
an angular inner rod, containing a limiting seat and a protruding end, said limiting seat sliding in the chamber of the inner slide, whilst the protruding end protrudes towards the guide slot of the outer cylinder after passing through the reducing port of the inner slide, the protruding end under a preset maximum protruding state being protruded out of the first polygonal slot of the outer cylinder, the protruding end under a preset maximum retraction state being retracted into the guide slot of the outer cylinder;
an elastic supporting member, being assembled into the chamber of the inner slide to support flexibly the angular inner rod towards the guide slot of the outer cylinder;
a first locating member, being placed onto the preset location of the chamber of the inner slide, and used to position the protruding end of the angular inner rod under preset maximum protruding state; and
a second locating member, arranged between the guide slot of the outer cylinder and the angular inner rod, enabling the preset maximum retraction state of the angular inner rod to be locked securely.

2. The tool connecting rod defined in claim 1, wherein the cross sections of the first and second polygonal slots are a hexagonal pattern.

3. The tool connecting rod defined in claim 1, wherein the cross sections of the inner slide and guide slot of the outer cylinder form a polygonal pattern, such that the inner slide can slide directionally.

4. The tool connecting rod defined in claim 1, wherein the retainer is comprised of a longer groove at one side of the inner slide, and a flanged pin correspondingly to the guide slot of the outer cylinder.

5. The tool connecting rod defined in claim 1, wherein the mating end of the drive rod is tightly inserted into the chamber of the inner slide for secure positioning.

6. The tool connecting rod defined in claim 1, wherein the elastic supporting member is comprised of a helical spring.

7. The tool connecting rod defined in claim 1, wherein the first locating member is comprised of a through-hole arranged on the side wall of the chamber of the inner slide, and a bead in the through-hole, wherein, when the protruding end of the angular inner rod is under a preset maximum protruding state, and the inner slide is retracted into the guide slot of the outer cylinder, the interior of the bead is solidly protruded from the chamber of the inner slide and abutted onto the limiting seat of the angular inner rod, wherein a tank is laterally set on the guide slot of the outer cylinder, and wherein, when the inner slide is pulled externally, the bead aligning with the tank can be retracted for a release state, such that the angular inner rod can slide inwards.

8. The tool connecting rod defined in claim 1, wherein the second locating member contains an elastic bead protruded laterally on the angular inner rod, and a bumping post arranged correspondingly to the guide slot of the outer cylinder, said angular inner rod is under a preset maximum retraction state, the elastic bead is used for abutting securely onto the bumping post.
